(19) United States
(12) Patent Application Publication
(10) Pub. No.: US 2008/0122609 A1
(43) Pub. Date: May 29, 2008

(54) SOLUTION FOR AUTOMATICALLY PROVIDING EMERGENCY RESPONDERS WITH DETAILED INFORMATION USEFUL FOR RESPONDING TO AN EMERGENCY

(75) Inventors: AMY C. MANNISTO, SUNRISE, FL (US); KIESHA D. GRANT, SUNRISE, FL (US); AMY M. TUPLER, HOLLYWOOD, FL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/671,083

(22) Filed: Feb. 5, 2007

Related U.S. Application Data
(60) Provisional application No. 60/867,743, filed on Nov. 29, 2006.

(51) Int. Cl. G08B 19/00

(52) U.S. Cl. 340/500

(57) ABSTRACT

The present invention discloses a method for responding to an emergency event. The method can start when a triggering event is detected by an emergency system inside a building. Next, the security state of a computing system associated with the building can change to indicate the emergency. An emergency responder can then be dispatched to the building to attend to the detected emergency. The emergency responder can be provided with previously unavailable information about the building that is helpful for an effective response to the emergency.

### CROSS-REFERENCE TO RELATED APPLICATIONS

The present application claims the benefit of U.S. Provisional Application No. 60/867,743 filed 29 Nov. 2006, which is hereby incorporated by reference herein.

### BACKGROUND

1. Field of the Invention

The present invention relates to emergency response systems and, more particularly, to providing emergency responders with detailed information pertaining to an emergency in an automated fashion.

2. Description of the Related Art

The routine of daily life in one's home carries with it a multitude of underlying hazards. Falling down the stairs, elevated carbon monoxide levels, injuries from tools, and accidental fires are but a few of the potential dangers lurking in a home. To tend to affected persons when such emergencies occur, emergency responders, such as paramedics and firefighters, are typically dispatched to the scene with inadequate and outdated information. These emergency responders routinely brave adverse and unknown conditions in the attempt to rescue trapped and injured homeowners and pets from danger. Unfortunately, these courageous responders are often injured by the very conditions from which they are attempting to rescue others.

The inherent chaotic nature of an emergency situation, which typically increases miscommunication, is often as much a cause of injury and death for emergency responders as the actual emergency. For example, firefighters are routinely injured when they continue searching dangerous areas for potential victims, which are not present. Further, many victims are harmed or perish because emergency responders where simply unaware of their plight and location.

Aside from the obvious hazards of an emergency situation, additional hidden dangers exist, such as explosions caused by oxygen tanks and gasoline containers, which increase the chance of injury to victim and responders and that often hinder rescue efforts. Emergency responders unfamiliar with a building's layout must waste valuable time orientating themselves, increasing their exposure to the unsafe environment and hindering their ability to rescue victims effectively.

Further, the actual environment that is used to protect victims often impedes rescue efforts. Emergency responders must take additional time to reach incapacitated or helpless victims located in locked or blocked areas, increasing harmful exposure for both parties. For example, firefighters must take the time to break through a locked door to reach a trapped unconscious victim. Likewise, a combination lock on a kennel gate can prevent the rescue of a beloved pet.

What is needed is a solution that provides emergency responders with information that is critical to the rescue of individuals and pets during an emergency. Such information would include the location of living beings within the affected area, the location of hidden dangers, a building layout, and the like. Ideally, this information would be provided to the emergency responders automatically in a real-time manner, and continuously and dynamically updated to reflect any relevant changes.

### SUMMARY

The present invention discloses a solution that automatically and dynamically provides emergency responders with key information that is useful when responding to an emergency. The solution can provide this information to an in-vehicle system or computing device that is accessible by the emergency responders and/or to mobile devices that they carry. The information can be automatically gathered once an emergency event is triggered. In one embodiment, the locations of living entities within a building can be automatically and dynamically determined using a location sensor, such as a Global Positioning System (GPS) equipped device (e.g., a cell phone carried by a trapped person), a BLUETOOTH-enabled device, a Radio Frequency Identification (RFID) tag and corresponding RFID scanners positioned within a building, and the like. Further, automatic locks can be automatically opened for emergency responders responsive to access codes transmitted by a mobile device carried by a responder. Additionally, in-building automation systems can automatically provide data, such as surveillance video of interior rooms or pictures of interior rooms to these mobile devices.

The present invention can be implemented in accordance with numerous aspects consistent with the material presented herein. For example, one aspect of the present invention can include a method for responding to an emergency. The method can start when a triggering event is detected by an emergency system inside a building. Next, the security state of a computing system associated with the building can change to indicate the emergency. An emergency responder can then be dispatched to the building to attend to the detected emergency. The emergency responder can be provided with previously unavailable information about the building that is helpful for an effective response to the emergency.

Another aspect of the present invention can include a method to assist emergency responders during an emergency. The method can include attaching location sensors to living occupants of the building. The location sensors can be used by a computing system to automatically and dynamically determine the location of tagged occupants. Next, an emergency event can be detected and an emergency responder dispatched to the building. The location information of the living beings inside the building can then be conveyed to a computing device accessible by the emergency responder.

Still another aspect of the present invention can include an emergency response system. The system can include multiple location sensors, a computing device. an emergency detection system, and a mobile device accessible by emergency responders. The location sensors can be attached to living beings and contain data pertaining to the attached being. The computing device can be configured to dynamically determine the location of the living beings inside a building using the location sensors. The emergency detection system can detect emergencies related to the building. The mobile device can be automatically provided information about the building by the emergency detection system, such as the location of living beings and the data stored within the location sensors.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system that illustrates how useful information can be provided to an emergency responder in accordance with the inventive arrangements disclosed herein.

FIG. 2 is a flow chart of two methods detailing the actions taken by a security system within the emergency environment and the external emergency response system in accordance with an embodiment of the inventive arrangements disclosed herein.

FIG. 3 is a schematic diagram of a building depicting an environment that can facilitate the communication of useful information to an emergency responder in accordance with an embodiment of the inventive arrangements disclosed herein.

FIG. 4 is a graphical user interface (GUI) displaying the useful information communicated to an emergency responder in accordance with an embodiment of the inventive arrangements disclosed herein.

FIG. 5 is a graphical user interface (GUI) providing an emergency responder with access to security video in accordance with an embodiment of the inventive arrangements disclosed herein.

### DETAILED DESCRIPTION OF THE INVENTION

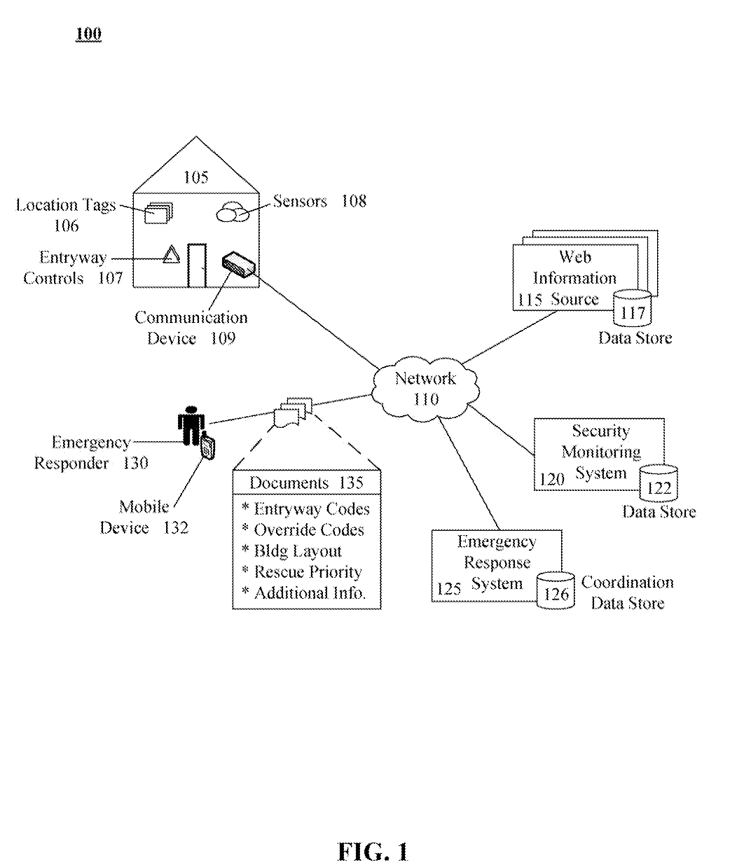

FIG. 1 is a schematic diagram of a system 100 that illustrates how useful information can be provided to an emergency responder 130 in accordance with the inventive arrangements disclosed herein. In system 100, the structure 105 can represent an entire building or a specific portion of a building, such as an apartment, where an emergency is occurring. The structure 105 can contain location tags 106, sensors 108, entryway controls 107, and a communication device 109.

The occurrence of an emergency event at the structure 105 can be relayed to the security monitoring system 120 via a communication device 109 over network 110. This communication device 109 can be a component of a more extensive security system. Likewise, such a security system can include entryway controls 107 in which an access code can be entered to unlock the entryway. The entryway controls 107 can include a variety of input mechanisms, including, but not limited to, a keypad, a magnetic strip reader, a smart card reader, a biometric reader, and the like.

Additionally, structure 105 can contain one of more sensors 108 used to detect emergency events. These sensors 108 can include a variety of sensing devices, including, but not limited to, smoke detector, carbon monoxide detectors, motion detectors, and the like. The detection of an emergency by any sensor 108 can result in the notification of the security monitoring system 120.

The location tags 106 can be used to designate the locations of living beings and/or potential hazards, such as combustible objects. These location tags 106 can utilize a variety of technologies, such as GPS-equipped devices, BLUETOOTH-enabled devices, RFID devices, and the like.

Upon receipt of a notification of an emergency at the structure 105, the security monitoring system 120 can notify the appropriate emergency response system 125. The security monitoring system 120 can represent a variety of commercially available services that monitor the status of sensors 108 within a structure 105, such as BRINKS HOME SECURITY and ADT SECURITY services. The security monitoring system 120 can include data store 122 containing a variety of information pertaining to the occupants and/or the structure 105. For example, data store 122 can include the access codes for the entryway controls 107, emergency contact numbers, and a rescue priority of occupants.

The emergency response system 125 can correspond to an emergency system, such as a 911 system local to the structure 105 that dispatches an emergency responder 130. For example, detection of a fire by the security monitoring system 120 would trigger the notification of the fire department closest to the structure 105. The emergency response system 125 can include a coordination data store 126 that can be configured to collect information pertinent to a specific emergency event from a variety of sources. This information can include the information contained within the data store 122 of the security monitoring system 125.

The coordination data store 126 can also obtain information regarding the structure 105 from the data store 117 of various Web information sources 115. These Web information sources 115 can represent sites of publicly available information, such as floor plans, as well as secure information such as health records. For example, the coordination data store 126 can receive a link from the security monitoring system's 120 data store 122 to an individual's hospital records. The coordination data store 126 can then access the hospital records via this link and gather the data for transmission to the emergency responder 130.

An emergency responder 130 can be sent to the structure 105 to address the emergency situation. The emergency responder 130 can possess a mobile device 132 that can be configured to receive documents 135 over network 110 from the coordination data store 136 of the emergency response system 125. As shown in this illustration, the documents 135 can contain entryway access codes, override codes, the building layout, a rescue priority, and additional information that can be useful in responding to the emergency. The emergency responder 130 can then access the documents 135 on the mobile device 132 when assessing and executing rescue efforts at the structure 105.

As used herein, presented data stores, including stores 117, 122, and 126, can be a physical or virtual storage space configured to store digital information. Data stores 117, 122, and 126 can be physically implemented within any type of hardware including, but not limited to, a magnetic disk, an optical disk, a semiconductor memory, a digitally encoded plastic memory, a holographic memory, or any other recording medium. Each of the data stores 117, 122, and 126 can be a stand-alone storage unit as well as a storage unit formed from a plurality of physical devices. Additionally, information can be stored within data stores 117, 122, and 126 in a variety of manners. For example, information can be stored within a database structure or can be stored within one or more files of a file storage system, where each file may or may not be indexed for information searching purposes. Further, data stores 117, 122, and/or 126 can utilize one or more encryption mechanisms to protect stored information from unauthorized access.

Network 110 can include any hardware/software/and firmware necessary to convey data encoded within carrier waves. Data can be contained within analog or digital signals and conveyed though data or voice channels. Network 110 can include local components and data pathways necessary for communications to be exchanged among computing device components and between integrated device components and peripheral devices. Network 110 can also include network equipment, such as routers, data lines hubs, and intermediary servers which together form a data network, such as the Internet. Network 110 can also include circuit-based communication components and mobile communication components, such as telephony switches, modems, cellular communication towers, and the like. Network 110 can include line based and/or wireless communication pathways.

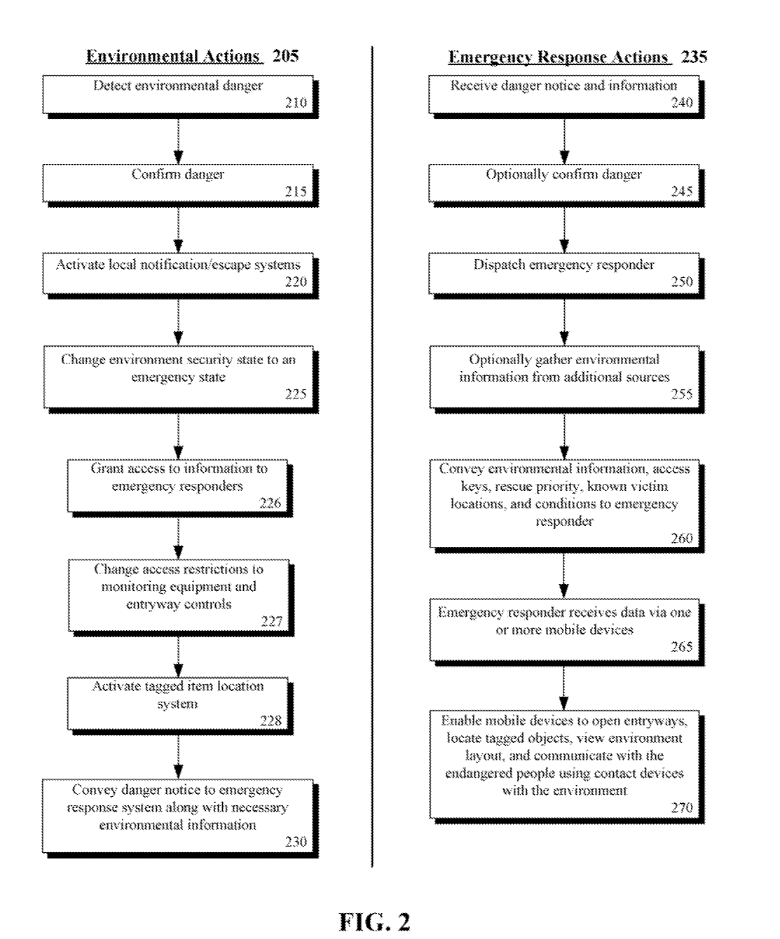

FIG. 2 is a flow chart of two methods 205 and 235 detailing the actions taken by a security system within the emergency environment and the external emergency response system in accordance with an embodiment of the inventive arrangements disclosed herein. These methods 205 and 235 can be performed in the context of system 100 or any other system that can provide useful information to emergency responders.

Method 205 can illustrate the steps taken by a security system within the environment where an emergency is occurring. Method 205 can begin with step 210 where the system detects an environmental danger, such as a fire or unsafe carbon monoxide levels. In step 215, the system can confirm the danger. Confirmation can be determined by taking additional readings such as readings from an auxiliary sensor, or any means available to the system.

When the danger is confirmed, the system can activate the local notification and/or escape systems in step 220. For example, the security monitoring system 120 would be notified by the communication device 109 in system 100. In step 225, the environmental security state of the system can be changed to reflect the emergency. Step 225 can include sub-steps 226 through 228.

Emergency responders can be granted access to environmental and other stored information in step 226. In step 227, the access restrictions to monitoring equipment and controls can be altered to allow access by emergency responders. Then, the item location system can be activated in step 228. Lastly, a danger notice and pertinent information can be sent to the emergency response system in step 230.

Method 235 can illustrate the steps taken by an emergency response system during an emergency notification. Method 235 can begin with step 240 where the system receives a notice of danger and accompanying information, such as that generated by step 230 of method 205. In step 245, the emergency response system can optionally confirm the danger.

An emergency responder can be dispatched to the scene in step 250. In step 255, the emergency response system can optionally gather environmental information from additional sources, such as Web information sources 115 of system 100. All the collected information can be conveyed to the emergency responder in step 260.

In step 265, the emergency responder can receive the sent information on one or more mobile devices. The emergency responder can then, in step 270, perform a multitude of actions with the received information, such as open electronically locked entryways by transmitting an access code from the mobile device to the controls, view the environment layout, communicate with the endangered people, and the like. It should be noted that the actions an emergency responder can take are dependent upon the information received and the device being used. For example, a hand-held computer can display a building layout, but may be unable to establish mobile communications with a victim.

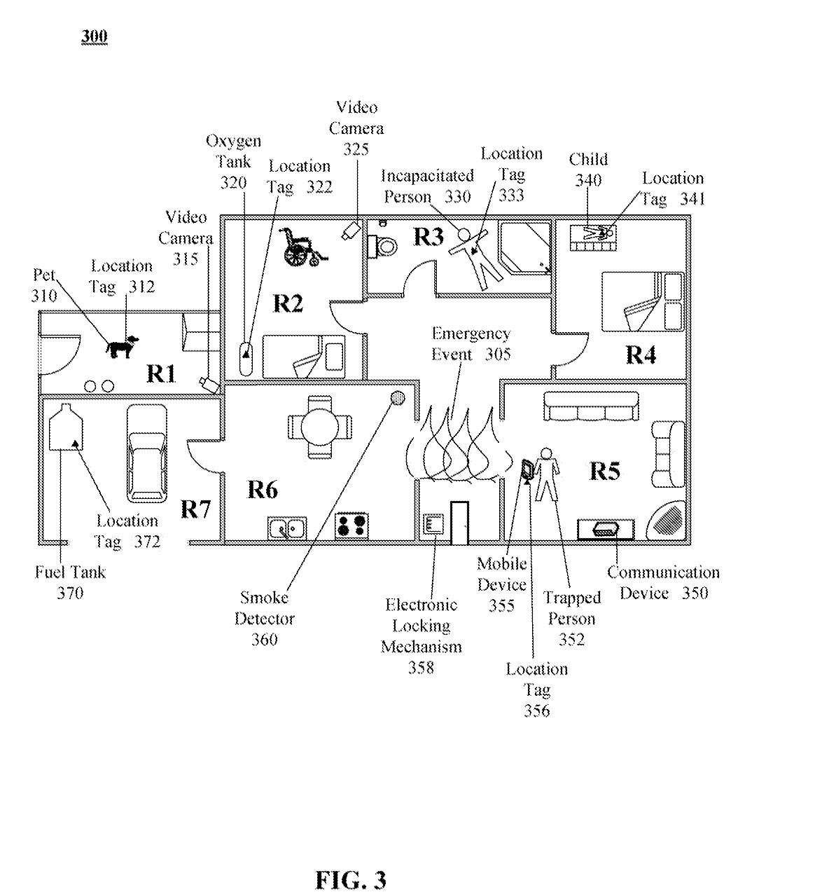

FIG. 3 is a schematic diagram of a building 300 depicting an environment that can facilitate the communication of useful information to an emergency responder in accordance with an embodiment of the inventive arrangements disclosed herein. Building 300 can be a representative example of he structure 105 of system 100.

Building 300 can contain a variety of interior and exterior compartments. In this example, building 300 consists of seven compartments, designated R1 through R7. R1 can represent a dog kennel. R2 can represent the bedroom of an elderly and ailing adult occupant. R3 can represent a bathroom. R4 can represent a bedroom with an adult and a child occupant. R5 can represent a living room or parlor. R6 can represent a kitchen. R7 can represent a garage that is attached to the home structure.

In this example, building 300 contains an emergency event 305, a house fire. This emergency event 305 can be detected by the smoke detector 360 located in R6. Conventionally, firefighters and paramedics responding to the emergency event (fire) 305 would enter the building 300 essentially blind. However, the system implemented within building 300 can provide the responders with the location of occupants, hazardous objects, and access to security camera footage prior to entering the building 300.

In R1, an emergency responder can be given access to control video camera 315 so they may visually inspect the situation. Since the responder has already received information stating that a pet 310 is located in R1, they can visually confirm the condition of the pet 310. The locational information of the pet 310 can be provided by a location tag 312 contained within the pet's 310 collar.

Similarly, responders can use video camers 325 to determine the risk posed to the oxygen tank 320 in R2. Since the oxygen tank 320 contains a location tag 322, responders can be made aware of its presence before entering the building 300. It should be appreciated that the ability to assess such risk prior to entry can significantly reduce injuries from such hidden dangers and increase the efficiency of rescue efforts.

The locational information provided by location tag 333 can help responders determine that person 330 is incapacitated or otherwise unable to move. Because locational data can be continuously received from the location tag 333, the data can be analyzed for trends. A stationary trend determined from the locational information can indicate to responders that a person 330 has succumbed to injury or is incapacitated. Additionally, the location tag 333 can contain important medical information, such as preexisting conditions pertaining to the incapacitated person 330 that can assist in their treatment by medical responders.

The location of the fire (emergency event 305) can cause person 352 to become trapped within the living room (R5). The trapped person 352 can be carrying a mobile device 355 that contains a location tag 356. Thus, the mobile device 355 can be used to communicate with responders as well as provide locational information for the trapped person 352. Also contained within R5 is a communication device 350. This communication device 350 can correspond to the communication device 109 of system 100. Thus, the communication deice 350 can transmit the various pieces of environmental data, such as video feeds and locational information, to the responders.

Responders can be also presented with the locational information of a child 340 in R4 and a fuel tank 370 in R7. A location tag 341 and 372 can be attached to each object, respectively. The responders can also be given the access code to the electronic locking mechanism 358 for the front door of the building 300. Having this information ahead of time allows the door to be opened with little delay to the rescue effort.

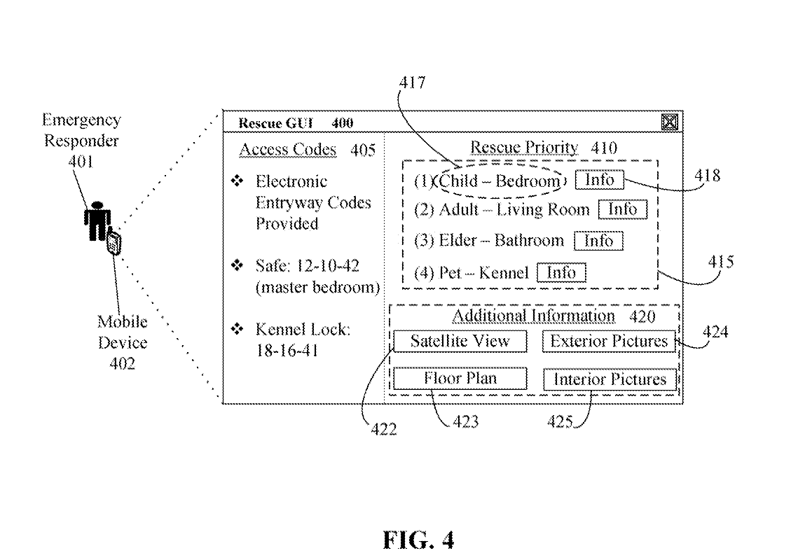

FIG. 4 is a graphical user interface (GUI) 400 displaying the useful information communicated to an emergency responder in accordance with an embodiment of the inventive arrangements disclosed herein. This GUI 400 can be used within the context of system 100 or any other system that can provide useful information to emergency responders. The rescue GUI 400 can be utilized by an emergency responder 401 on a mobile device 402. The information displayed in the GUI 400 can be the information collected by the coordination data store 126 of system 100.

As shown, the rescue GUI 400 can include sections displaying access codes 405, rescue priority 410, and additional information 420. The access codes section 405 can include a digital code that can be transmitted to an electronic lock as well as codes for locks that must be manually unlocked. Codes displayed in the access codes section 405 can be for containers, such as safes and kennels, not just portals.

The rescue priority section 410 can display a predetermined list designating the order in which occupants are to be rescued from the building. It should be noted that this list must have been created by an authorized agent prior to the emergency, and that the rescue priority of occupants would be at the discretion of emergency responders in the absence of a predetermined list.

An entry in the rescue priority list 415 can include the occupant's identification and location 417 and an information button 418. The locational information can be obtained by a location detection system, such as the use of location tags in FIG. 3. Selection of the information button 418 by the emergency responder 401 can result in the display of vital information for the identified occupant. This information can be displayed in the rescue GUI 400, replacing the currently displayed information, or can be presented in a separate window.

The additional information section 420 can provide an emergency responder 401 with access to collected environmental information. In this example, the additional information section 420 contains a satellite button 422, floor plan button 423, an exterior button 424, and an interior button 425. Selection of the satellite button 422 can provide the emergency responder 401 with a satellite picture of the specified building, similar to those provided by GOOGLE EARTH. Selection of the floor plan button 423 can display a drawing of the building's floor plan to help the emergency responder 401 understand the layout before entering.

Selection of either the exterior or interior buttons 424 and 425 can provide the emergency responder 401 with live video images obtained from security cameras located within the building. In the event that the video cameras are disabled, these buttons can statically display the last image received from the camera or an image from a point prior to the emergency.

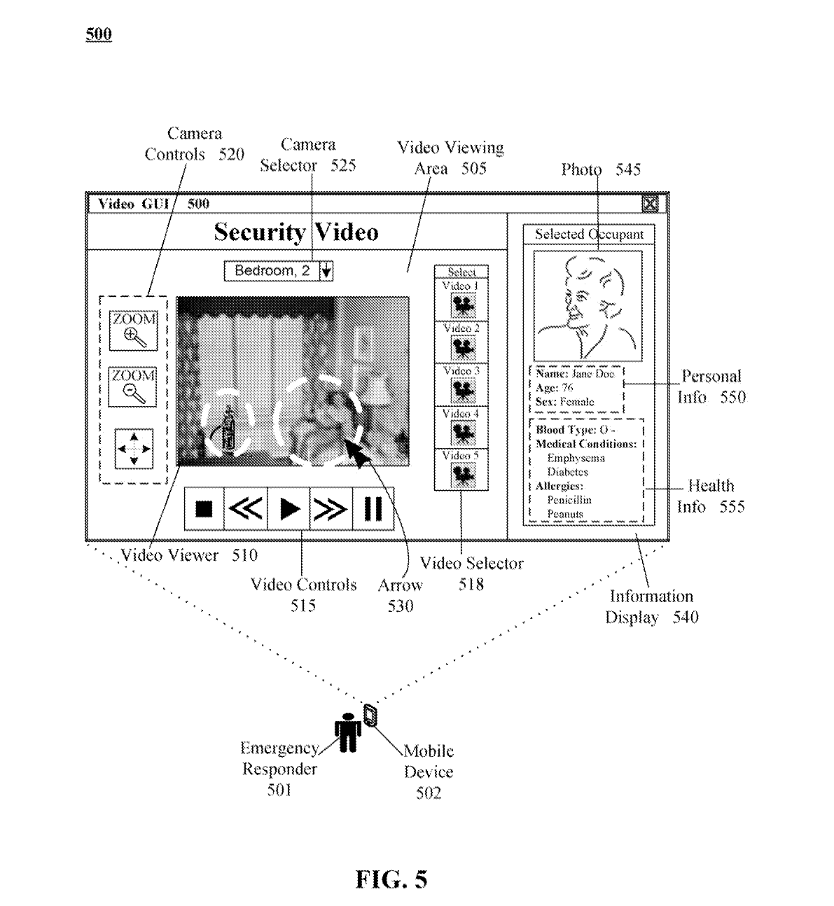

FIG. 5 is a graphical user interface (GUI) 500 providing an emergency responder with access to security video in accordance with an embodiment of the inventive arrangements disclosed herein. The video GUI 500 can be utilized by an emergency responder 501 on a mobile device 502. This video GUI 500 can be launched by the selection of the exterior 424 or interior buttons 425 of rescue GUI 400.

This video GUI 500 can include a video viewing area 505 and an information display 540. The video viewing area 505 can include a video viewer 510, video controls 515, a video selector 518, camera controls 520, and a camera selector 525. The video viewer 510 can display live or recorded video images from a video camera located inside the building.

By utilizing the video controls 515 and video selector 518, an emergency responder can select and/or replay an available video. The camera controls 520 can allow the emergency responder 501 to reposition or change the magnification of a selected video camera in order to visualize the entirety of the area. An emergency responder 501 can switch between multiple cameras within a building by using the camera selector 525.

Items being viewed in the viewer 510 that contain a location tag can be emphasized to the emergency responder 501, shown in this example by the white dotted circles. An emphasized object can be selected via a mechanism, such as arrow 530, and its information presented in the information display 540.

The displayed information for an object can include a photo 545, personal information 550, and health information 555. This information can be provided by an authorized agent prior to the emergency, such as during the installation of a security system, and/or collected by the emergency response system. It should be appreciated that this information is not normally available to an emergency responder 501 and often distributed amongst a variety of systems.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. An emergency response method comprising:
detecting a triggering event of an emergency system associated with a building;
changing a security state for a computing system corresponding to the building from a normal state to an emergency state; and
at least one emergency responder being deployed to the building in response to the triggering event, wherein the responder is provided with information associated with the building that is helpful in responding to the triggering event that would be unavailable to the responder when the computing system is in the normal state.

2. The method of claim 1, wherein the information includes an access key for gaining access to at least one of a locked entryway and a locked container of the building.

3. The method of claim 2, wherein the access key is one part of a two part key, the other part of the key being provided by the computing system while the computing system is in the emergency state.

4. The method of claim 2, further comprising:
conveying the access key to a mobile device of the emergency responder; and
the mobile device wirelessly conveying the access key to at least one of the entryway and the locked container, which changes from a locked to an unlocked state based upon the received access key.

5. The method of claim 1, further comprising:
automatically determining a location of living entities inside the building; and
conveying the determined locations to the emergency responder.

6. The method of claim 5, wherein the automatic determination of the location is based upon a location identifier attached to each of the living entities, wherein the location of each living entity is dynamically and repetitively updated, said method further comprising:
conveying the dynamically and repetitively updated location information to a mobile device of the responder.

7. The method of claim 6, wherein the location identifier is associated with a memory space including information specific to the attached living entity, which is automatically conveyed to the mobile device.

8. The method of claim 7, wherein the location identifier is associated with a priority code, said method further comprising:
prioritizing the living entities based upon the priority code; and
presenting a prioritized list of emergency response objectives of which of the living entities are to receive priority attention based upon the priority code.

9. The method of claim 1, wherein at least one fixed object potentially harmful to the emergency responder is tagged, said tag including information specific to the object, said method further comprising:
automatically and wirelessly conveying the information specific to the object to a mobile device of the responder.

10. The method of claim 1, further comprising:
automatically acquiring an interior layout of the building; and
conveying the interior layout to the emergency responder.

11. The method of claim 1, further comprising:
a media receiving device in the building capturing input; and
automatically conveying the captured input to a mobile device of the emergency responder.

12. The method of claim 11, wherein the captured input includes at least one of sound and video.

13. The method of claim 1, wherein said steps of claim 1 are performed by at least one machine in accordance with at least one computer program having a plurality of code sections that are executable by the at least one machine.

14. A method for assisting emergency responders during an emergency comprising:
attaching a location sensor to a plurality of living beings, said location sensor permitting a computing system to automatically and dynamically determine a relative location of the living beings within a building:
detecting an emergency event related to a building;
dispatching at least one emergency responder to the building; and
conveying location information of the living beings obtained from the location sensors to a computing device accessible by the emergency responder.

15. The method of claim 14, wherein the location sensors comprise BLUETOOTH transceivers, wherein the computing device accessible to the emergency responder is a mobile computing device having a BLUETOOTH transceiver, wherein the mobile computing device automatically detects each of the location sensors when the mobile computing device is proximate to the location sensors.

16. The method of claim 14, further comprising:
automatically prioritizing a rescue order for each of the living beings; and
conveying the prioritized rescue order to the computing device accessible by the emergency responder.

17. The method of claim 14, wherein the computing device accessible by the emergency responder is a mobile computing device carried by the emergency responder, said method further comprising:
conveying unlock codes to the mobile computing device for potentially locked objects in the building, said locked objects including at least one of a door, a gate, a pet container, a safe, and a box.

18. The method of claim 14, wherein each of the location sensors comprises a data store within which data specific to the attached living being is stored, said conveying step further comprising:
conveying data from the data store to the computing device accessible by the emergency responder.

19. The method of claim 14, further comprising:
attaching an item location sensor to a plurality of dangerous items in the building; and
conveying location information from the item location sensors to the computing device accessible by the emergency responder.

20. An emergency response system comprising:
a plurality of location sensors attached to living beings, each of the location sensors including data related to the attached living being:
at least one computing device configured to dynamically determine a location within a building of each of the living beings using the location sensors;
an emergency detection system configured to detect an emergency related to the building; and
at least one mobile device configured to be utilized by an emergency responder, wherein when the emergency detection system detects an emergency related to the building, the mobile device is automatically granted heightened access to information pertaining to the building, wherein the information is automatically provided to the mobile device, the information including at least a portion of the data stored in the location sensors and including a location of the living beings within the building.
